(19) United States
(12) Patent Application Publication
(10) Pub. No.: US 2014/0146381 A1
(43) Pub. Date: May 29, 2014

(54) Optically variable thin film with electrochemical capacitance property and use thereof

(71) Applicant: National Taiwan University, Taipei (TW)

(72) Inventors: Lin-Chi Chen, Taipei (TW); Tzu-Chieh Liao, Taipei (TW); Siang-Fu Hong, Taipei (TW); Chia-Hao Chang, Taipei (TW)

(73) Assignee: National Taiwan University, Taipei (TW)

(21) Appl. No.: 13/900,377

(22) Filed: May 22, 2013

(30) Foreign Application Priority Data
Nov. 23, 2012 (TW) 101143939

(51) Int. Cl. G02F 1/15

(52) U.S. Cl. CPC G02F 1/15
USPC 359/265

(57) ABSTRACT

The present invention relates to an optically variable thin film with electrochemical capacitance property, comprising electrochromic particles embedded with transparent gel-type electrochemical-capacitor material; the present invention also provides a product with a discoloration appearance, comprising an optically variable thin film of the present invention.

### FIELD OF THE INVENTION

The present invention relates to an optically variable thin film with electrochemical capacitance property; the present invention also provides a product with an optically variable appearance.

### BACKGROUND OF THE INVENTION

Introduction of Electrochromic Device

Electrochromic is the phenomenon that when a kind of material is subject to an external electric potential, it undergoes redox reaction and exhibits change in its absorption spectrum. This kind of material is called electrochromic material. Electrochromic phenomenon was discovered by S. K. Deb and J. A. Chopoorian in 1968. Today, the application of electrochromic has now gradually become a part of our daily life. Its typical usage is the energy-saving electrochromic windows, which changes the color of the glass to subdue the intensity of light, in order to save the energy. Another is on the vehicles, electrochromic windows can reduce the glare to improve the safety while provide the passengers comfort. Electrochromic device can also be applied to monitors, for example, Kindle, E-ink and etc. Compared to the conventional monitors, electrochromic monitors are characterized by their energy-saving, flexible and light qualities. Also because they are non-luminous and suitable for durable reading, the electrochromic monitors possess great potential.

The structure and principle of the electrochromic device are similar to that of a repetitively chargeable and dischargeable electrochemical cell, the common assembling is a sandwich structure. In FIG. 1, the individual layers from top to bottom are a transparent conductor, an electrochromic layer, an ion conducting layer, a counter electrode layer and a transparent conductor of the counter electrode layer, which are described as following:

1. Transparent conductor: this layer provides the conduction pathway for the electrons, when the device is subject to an electrical potential, the electrons will be conducted through this layer and the reaction starts. The common transparent conductors are indium-doped tin oxide (ITO) or fluorine-doped tin oxide (FTO).

2. Electrochromic layer: electrochromic layer is central to this kind of devices, when the material in this layer accepts electrons from the conductor layer and cations from the electrolyte, the redox reaction begins, causing change in the light spectrum, which can be utilized in an energy-saving window or a monitor and etc.

3. Ion conducting layer: it's the source of the electrolyte. Compared to the transparent conductor, the ion conducting layer adopts ions to conduct. The anions/cations diffuse through this layer to the anode/cathode, starting the redox reaction. There are different suitable reactive ions for different materials, the common ones are KCl, LiClO₄, NaClO₄ and etc. Sometimes the electrolytes can also be made in colloid or even solid to avoid leakage in the device.

4. Counter electrode layer: the redox reaction in the electrochromic layer requires another counter redox reaction, which takes place in the counter electrode layer. The counter electrode layer stores the electrons or ions released by the electrochromic layer during its redox reaction, and sustains the electrical neutrality of the system. One will usually select transparent materials for a counter electrode layer, in order to match the variety of electrochromic material; or select complementary electrochromic device to vivify the changing color.

Electrochromic Material

Generally, there are four types of electrochromic materials: electron-conducting polymer, small organic molecules, metal oxide and Prussian blue analogue. Among them, the metal complexes are the main materials of the present invention; and because Prussian blue is the most well-know metal complex, these metal complexes are also named Prussian blue analogue (PBA). The relevant researches are Arancibia et al., 1999; Bharathi et al., 2001 in FeHCF; Carpenter et al., 1990 in VHCF; Gao et al., 1991 in CoHCF and etc.

Introduction of Prussian Blue and its Analogues

Prussian blue is a well-known complex. With the advance of science, the characteristics of Prussian blue, including ferromagnetism, optical devices, solid rechargeable batteries, ion exchanging surface and electrochromic are being revealed. Studies are also in progress on those analogues with different colors due to complexing with different transition metals.

Development and Structure of Prussian Blue

Prussian blue is an insoluble compound. This is the key obstacle in its application in wet processes, including spray-coating, spin-coating, screen printing and etc. The main structure difference that causes the insolubility of Prussian blue lays in its crystal defects. The replacement of the crystal defects by water molecules will lead to electrical neutrality of the crystal and an aggregation of the Prussian blue particles, and eventually its insolubility in water. In contrast, when the crystal defects are replaced by potassium salts, the Prussian blue particles and water molecules will undergo peptization, thus the Prussian blue can be dispersed evenly in water.

Introduction of the Electrochemistry Properties of Prussian Blue

There are four oxidation and reduction states of Prussian blue, from reduction states to oxidation states are Prussian white, Prussian blue, Berlin green and Prussian yellow. The crystal structures of soluble and insoluble Prussian blue are different, hence their redox reaction are also different:

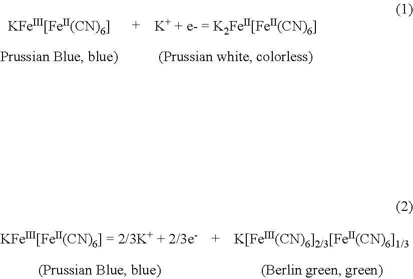

Evidently, Berlin green is the composite of Prussian blue and Prussian yellow. Besides, the redox reaction of the insoluble Prussian blue:

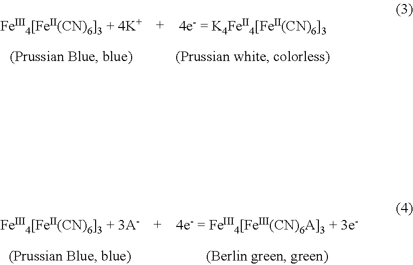

Wherein the A represents an anion in the electrolytes, ex. Cl⁻ or ClO⁴⁻. It is noted that the structure of Prussian blue is like a zeolite, hence, only when the hydrated radius of the electrolytic ion is smaller than the radius of the pore, which allows the ions to move in and out, can the reversible redox reaction take place.

Introduction of Prussian Blue Analogues

Besides Prussian blue, the hexacyanoferrate can complex with transition metal to produce transition hexa-cyanomerallte, including cobalt hexacyanoferrate (CoHCF), nickel hexacyanoferrate (NiHCF) and etc. Due to the similarity between these complexes and Prussian blue, they are also called Prussian blue analogues. These complexes can be divided into soluble type -GⱼM^{A}ₖ[M^{B}(CN)₆]₁ and insoluble type -M^{A}ₖ[M^{B}(CN)₆]₁, wherein the M^{A}, M^{B} stand for transition metals with different oxidation states, Gⱼ is a monovalent cation. The electrochromic property of cobalt analogues is from purple to brown, and that of nickel analogues is from yellow to colorless. Iron-based nano complexes with different metal ions have different color variations. If introducing necessary analogues, one can expect to create composite thin films with any desired colors based on principles of the mixture of the three primary colors.

Progress of the Wet Processes of Prussian Blue Nano Particles

Macroscopically, the planarity and homogeneity of the thin film will affect its value and application in the visual products, including monitors, electronic books, energy saving windows and etc. Microscopically, the pores of Prussian nano particles, the deposition thickness of the thin film and the structure of the crystals will affect the qualities of thin film, including the ability of ions to move into and out from the thin film, or whether it can be applied to wet process. In wet process, the materials are applied on to a substratum by coating, the common methods include dip coating, spin coating, screen printing and etc. All the methods above are suitable for large area substratum.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the sandwich structure of the electrochromic device.

FIG. 2 shows the size distribution of Prussian nano particles before and after modification.

FIG. 3 shows the size distribution of nickel hexacyanoferrate particles before and after modification.

FIG. 4 shows the size distribution of cobalt hexacyanoferrate particles before and after modification.

FIG. 5 shows the size distribution of copper hexacyanoferrate particles before and after modification.

FIG. 6 shows the influence of re-electroneutralization on the relationship between the number of times the Prussian blue thin film is coated and the electric charge quantity on thin film.

FIG. 7 shows the EDS analysis of elements on the Prussian blue thin film after the re-electroneutralization with nickel ions.

FIG. 8 shows the CV responses of the Prussian blue thin film and the colors of the thin film under different redox states.

FIG. 9 shows the transmittance spectra of the Prussian blue thin film at different potentials.

FIGS. 10(a) and 10(b) show the XPS scanning results of the Prussian blue thin film (a) full spectra; (b) micro-area scanning of Fe 2p.

FIGS. 11(a), 11(b), and 11(c) show the surface structures of the Prussian blue thin film with (a)5 k; (b)50 k times magnification; and after 100 cycles of cyclic voltammetry scanning with (c)50 k times magnifications.

FIG. 12 shows the CV responses of the cobalt hexacyanoferrate thin film and the colors of the thin film under different redox states.

FIG. 13 shows the transmittance spectra of the cobalt hexacyanoferrate thin film at different potentials.

FIG. 14 shows the EDS analysis of elements on the cobalt hexacyanoferrate thin film.

FIGS. 15(a) and 15(b) show the surface structures of the cobalt hexacyanoferrate with (a)5 k and (b)100 k times magnifications.

FIG. 16 shows the CV responses of the nickel hexacyanoferrate thin film and the colors of the thin film under different redox states.

FIG. 17 shows the transmittance spectra of the nickel hexacyanoferrate thin film at different potentials.

FIGS. 18(a) and 18(b) show the XPS scanning results of the nickel hexacyanoferrate thin film (a) full spectra; (b) the comparison between micro-area scanning of Fe 2p of Prussian blue and that of nickel hexacyanoferrate.

FIGS. 19(a) and 19(b) show the surface structures of the nickel hexacyanoferrate with (a)5 k and (b)50 k times magnifications.

FIG. 20 shows the CV responses of the copper hexacyanoferrate thin film and the colors of the thin film under different redox states.

FIG. 21 shows the transmittance spectra of the copper hexacyanoferrate thin film at different potentials.

FIG. 22 shows the EDS analysis of elements on the copper hexacyanoferrate thin film.

FIGS. 23(a) and 23(b) show the surface structures of the copper hexacyanoferrate with (a)5 k and (b)50 k times magnifications.

FIG. 24 shows the CV responses of the compound film of Prussian blue and nickel-based analogue and the colors of the compound film under different redox states.

FIG. 25 shows the transmittance spectra of the compound film of Prussian blue and nickel-based analogue at different potentials.

FIG. 26 shows the CV responses of PNCECD.

FIG. 27 shows the the transmittance spectra of PNCECD.

FIG. 28 shows the the colors of PNCECD at −1.0V, −0.4V, 0.4V and 1.0V.

FIG. 29 shows the solar energy-saving performance of PNCECD.

FIG. 30 shows the structures of the thin films with different concentrations of zinc hexacyanoferrate nano particles observed by SEM electronic microscopic; the coating solution contains zinc hexacyanoferrate nano particles made from zinc acetate and (a)2 mM, (b)5 mM or (c)10 mM of potassium ferrocyanide; (d) the coating solution contains 5 mM of zinc hexacyanoferratedoped with 10% PEDOT:PSS; (e) the coating solution contains 5 mM of zinc hexacyanoferrate doped without PEDOT:PSS; (f) the coating solution contains 5 mM of zinc hexacyanoferrate doped with 10% PEDOT:PSS; magnification:(a)-(d)30,000 times; (e) and (020,000 times.

FIGS. 31(a) and 31(b) show the electrical quantities left on the anodes of the thin films (a) after the first cycle of cyclic voltammetry scanning; and (b) after various cycles of cyclic voltammetry scanning; wherein the thin films are coated with different concentrations of zinc hexacyanoferrate in combination with different concentrations of PEDOT:PSS.

FIG. 32 shows the EN spectra of the thin films, which are coated with 2 mM nickel hexacyanoferrate precipitants in combination with different concentration of PEDOT:PSS, respectively.

FIGS. 33(a) and (b) show the comparison between the CV responses of 20% PEDOT:PSS (v/v), 5% and 10% carbon gel (w/w).

FIG. 34 shows the comparison between the CV responses of Prussian blue doped with PEDOT PSS and Prussian blue doped with carbon gel.

FIG. 35 shows the model of a thin film with optically variable particles are embedded by transparent colloidal materials with electrochemical capacitance property.

FIG. 36 shows the equivalent circuit of a thin film with optically variable particles are embedded by transparent colloidal materials with electrochemical capacitance property.

FIG. 37 shows the CV responses of the thin films of Prussian analogues doped with PEDOT:PSS, carbon gel, graphene or multiwall carbon nanotubes (MWCNT), respectively.

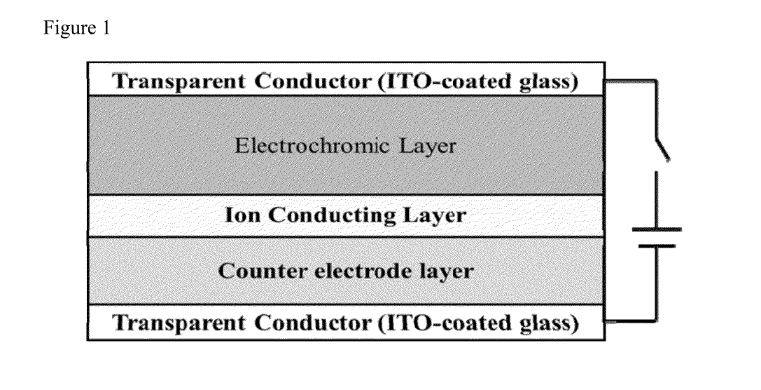

### SUMMARY OF THE INVENTION

The present invention provides an optically variable thin film with electrochemical capacitance property, wherein the thin film comprises nano particles of Prussian blue or its analogues, which are embedded with transparent colloidal materials with electrochemical capacitance property.

The present invention also provides a product with a discoloration appearance, comprising an optically variable thin film of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In describing and claiming the invention, the following terminology will be used in accordance with the definitions set forth below.

The term “a” or “an” used in the present disclosure is used to describe elements and components of the invention. This is done merely for convenience and to give a general sense of the invention. This description should be read to include one or at least one and the singular also includes the plural unless it is obvious that it is meant otherwise.

The term “or” used in the present disclosure refers to “and/or”.

The term “transparent” used in the present disclosure refers to the visual effect that allows high transmittance in visible spectrum and does not interfere with the coloration and decoloration of the optically variable particles.

The term “colloidal” used in the present disclosure refers to the consistency state that allows the application to wet processes including spin coating, dip coating, screen printing, spray coating and etc; and allows the even dispersion of the optically variable particles.

The term “materials with electrochemical capacitance property” used in the present disclosure refers to the electrode materials possessing properties of both Faradaic (electrochemical cell) and non-Faradaic capacitance (electrical double layer capacitance), wherein the electrode materials transfer or sink the electrons and ions required by the electrochromic reaction simultaneously

The present disclosure provides an optically variable thin film comprising single layer or multi-layer of single type or plural types of optically variable particles, wherein the optically variable particles are embedded by transparent colloidal materials with electrochemical capacitance property. In a preferred embodiment, the optically variable particles embedded by transparent colloidal materials with electrochemical capacitance property enhance a transfer property of electrons and ions in the electrochromic process. In another preferred embodiment, the enhanced transfer of electrons and ions in the electrochromic process leads to a thin film with higher optical density, higher contrast, more uniform coloration, better reversibility or longer lifespan. In yet another preferred embodiment, the optical variable particles embedded by transparent colloidal materials with electrochemical capacitance property generate electrochemical capacitance effect between the optically variable particles in the thin film.

The optically variable thin film can be applied to flexible, stiff, flat or non-flat conductive substrate. In a preferred embodiment, the conductive substrate is ITO glass.

The transparent colloidal materials with electrochemical capacitance property in the present disclosure are selected from the group consisting of inorganic transparent colloidal materials with electrochemical capacitance property, organic transparent colloidal materials with electrochemical capacitance property and mixtures thereof In a preferred embodiment, the organic transparent colloidal material with electrochemical capacitance property is PEDOT:PSS (poly(3,4-ethylenedioxythiophene)poly(styrenesulfobate)). In another preferred embodiment, the organic transparent colloidal material with electrochemical capacitance property is carbon

The optically variable particles in the present invention change their optical properties due to the redox reaction, and are dispersed homogeneously in transparent colloidal materials with electrochemical capacitance property due to chemical modifications on the surface of particles. In a preferred embodiment, the optically variable particles are selected from the group consisting of organic micron optically variable particles, inorganic micron optically variable particles, organic nano optically variable particles, inorganic nano optically variable particles and mixtures thereof. In a more preferred embodiment, the optically variable particles are electrochromic particles. In an even more preferred embodiment, the electrochromic particles are selected from the group consisting of Prussian blue, cobalt hexacyanoferrate, nickel hexacyanoferrate, copper hexacyanoferrate, indium hexacyanoferrate, zinc hexacyanoferrate and mixtures thereof. In another even more preferred embodiment, the electrochromic particles are blue, green_{;} yellow, red, brown or other colors.

In a preferred embodiment, if the optically variable thin film comprises two or more kinds of optically variable particles, the optical properties of the different kinds of optically variable particles do not interfere with each other. In a more preferred embodiment, the electrochromic particles are Prussian blue or nickel hexacyanoferrate.

The present invention also provides a device with optically variable appearance, the configuration of the device comprises the optically variable thin film of the present invention. In a preferred embodiment, the device comprises flat panel display module (including transmission type and reflection type), electronic paper display (including transmission type and reflection type), electrochromic device (including electrochromism), solar-energy-generator-device-driven coloration, electrochromism induced by signals from light, heat or sound sensors, coloration induced by redox gas, liquid; for application in construction, interior design, transportation, ornamentation etc), optical filters, lens, glasses, mirrors which alter the spectral characteristic after being applied with external electric field or redox reagent (including transmission type and reflection type) electrochemical capacitors, batteries, redox indicators, chemical sensors, biological sensors, all of the devices and products possess optically variable appearance.

The present invention provides the first thin film electrode which employs colloids with electrochemical capacitance property as the substrate to embed and to fix the electrochromic particles and to transfer the electrons and ions, in order to facilitate the coloration of the electrochromic particles.

The manufacture procedure of a particulate thin film is relatively easy, it can be applied to any wet process, and is suitable for flexible, rigid, conductive and non-conductive substrate. But there remain some problems in the manufacture of electrochromic particulate thin films, including non-homogeneous coating, non-homogeneous coloration, some materials are even unable to effectively transfer the electrons and ions required by the electrochromic reactions in a discontinuous particulate thin film, causing an inactive coating. The present invention employs transparent colloidal materials with electrochemical capacitance property, which will not interfere with the electrochromic reaction, as the homogeneous dispersion substrate for the electrochromic particles. The present invention also employs the electrochemical capacitor, which simultaneously transfers and sinks electrons and ions, to confer the activity of coloration upon redox reaction on the non-continuous electrochromic particles. The present invention allows a colloidal material with electrochemical capacitance property to composite with one or more kinds of electrochromic particles, or uses multiple layers of the said thin films to achieve the electrochromic thin film electrode with polychrome.

The said composite materials can be applied to wet processes, including spin coating, spray-coating, dip-coating, screen printing and etc, on flexible, rigid, flat or non-flat conductive substrates, to manufacture electrochromic thin film electrodes with homogenous coloration/discoloration.

### EXAMPLES

The examples below are non-limiting and are merely representative of various aspects and features of the present invention.

### Example 1

1. Preliminary Process of Conductive Glass Substrates

First, the ITO conductive glass is cut to the size of 3 cm×4 cm by diamond cutting blade. Before film formation, the cut ITO glass is washed in 0.1 M hydrochloric acid and deionized water by sonicator for 5 minutes respectively. The moisture on the surface of the glass is blown dry by nitrogen gas. After the cleaning steps, a length of copper foil adhesive tape is adhered to the width of the glass for electron conduction bus, and then the epoxy resin adhesive tape is used to confine the working area on ITO glass to the size of 2 cm×2 cm for later quantitative analysis.

2. Preparation of the Nano Particles of Prussian Blue and its Analogues

For Prussian blue coating solution, 50 ml ferric chloride solution of 0.1 M is prepared with deionized water, and then 50 ml potassium ferrocyanide solution of 0.1M is added into the ferric chloride solution and stirred for 5 minutes. Prussian blue precipitates are obtained by discarding the supernatant after high-speed centrifugation. The preparations for cobalt, nickel and copper-based analogues are similar. 50 ml cobalt chloride, nickel chloride or copper sulfate solution of 0.1 M is individually prepared with deionized water, but this time, 50 ml potassium ferricyanide solution of 0.1 M is added into the solution instead, and stirred for 5 minutes. The precipitates of the Prussian blue cobalt, nickel and copper analogues are obtained by discarding the supernatant after high-speed centrifugation. The precipitates of Prussian blue and nickel hexacyanoferrate are not able to dissolve in water homogeneously, hence the modifications of the surfaces of precipitates are required, which are to stir the precipitates in potassium ferrocyanide solution for 72 hours. The soluble precipitates are obtained after high-speed centrifugation.

The preparation of zinc hexacyanoferrate nano particle is to add potassium ferricyanide or potassium ferrocyanide solution into zinc acetate solution, which is in continuous agitation, for equal molar quantity. The present invention employs three precipitation concentrations: 2 mM, 5 mM and 10 mM for the mixture of potassium ferrocyanide and zinc acetate solution. After agitation for one hour, the white zinc hexacyanoferrate precipitates are collected by centrifugation, and washed by deionized water, then dispersed in suitable amount of deionized water to obtain 5% (w/w) zinc hexacyanoferrate nano particle supernatant solution. In order to clarify and homogeneously disperse zinc hexacyanoferrate solution for usage in spin coating, the large agglomerations are sieved by a sieve with 100 μm mesh. The preparation of zinc hexacyanoferrate thin film doped with PEDOT:PSS is the similar, 10% or 20% (v/v) PEDOT:PSS ink is added into the zinc hexacyanoferrate nano particle supernatant solution before spin coating.

3. Preparation of the Coating Solutions of Prussian Blue and its Analogues

The precipitates of Prussian blue and analogues are desiccated in vacuum oven for 72 hours, then dissolved to the concentration of 0.1 g/ml (dissolved in deionized water). The 20% (v/v) conductive polymer PEDOT:PSS, 5% or 10% (w/w) carbon gel is added into the solution to obtain spin coating solutions.

4. Spin Coating on ITO Conductive Glass

After the preliminary process of conductive glass substrates and the preparation of coating solution, a spin coating machine can be used to start the spin coating. Optionally, denser PEDOT:PSS is used to fine-adjust the viscosity of the coating solutions. The coated thin films of Prussian blue and nickel hexacyanoferrate are easily washed away by the ink during next coating, hence the coated thin film is first immersed in 1M nickel chloride DIW solution, then immersed in deionized DIW to wash away superfluous nickel ions. After the coating is complete, the thin film needs to be baked in 130° C. for 10 minutes to solidify the thin film electrode. In addition, it is noted that the Prussian composite thin film is manufactured “layer-by-layer”, which is to coat Prussian blue and nickel hexacyanoferrate onto the conductive glass layer by layer.

5. Assembly of Electrochromic Device

The Prussian blue analogue thin film is assembled into an electrochromic device for later simulation test. After the working electrode and auxiliary electrode are chosen, the thermal setting plastic is stuck to peripheral of the electrode, with an aperture left. The device is heated in 100° C. to seal the thermal setting film, then the electrolyte is injected with a syringe. Finally, the device is completely sealed with epoxy resin AB glue or silicone gel.

### Example 2

1. Characteristic Analysis of the Nano Particle in Coating Solution

A dynamic light scattering particle size analyzer was applied to analyze particle distribution, and to measure the zeta potential of the nano particles in the coating solution.

2. Photo-Electrochemical Analysis

(1) Three Electrode Electrochemical Analysis of Prussian Blue Analogue Thin Film

The single thin film would be analyzed by traditional three electrode electrochemical system. The system mainly used organic chemical propylene carbonate as solvent; the working electrode was Prussian blue thin film for analysis, the auxiliary electrode was platinum, the reference electrode was silver. A potentiostat/galvanostat was driven by computer program to carry out cyclic voltammetry, chronoamperometry, chronocoulometry and etc. In a three electrode electrochemical system, the cyclic voltammetry revealed the potential window, redox potential and stability of the thin film during reaction, and further calculated the diffusion rate of the ions in thin film. On the other hand, the chronoamperometry and chronocoulometry applied designated electrical potential back and forth to the thin film, in order to obtain the response electrical quantity and time of the material. And if a long-term redox test was carried out, the lifespan and stability of the device were simulated.

(2) in-situ UV-VIS Spectral Analysis

UV-VIS spectral analyzer was employed in combination with a potentiostat/galvanostat to proceed with a cohort photo-electrochemical measurement of the thin film, in order to know the spectral adjustability of the thin film during redox reaction. Besides the commonly used transmittance, absorbance and reflectance, the characteristic wavelength was obtained after a full spectrum scan; optical density variation (ΔOD) and coloration efficiency, which were parameters generally used in evaluating a chromic material, of the thin film were calculated with the following equation:

ΔOD=log(T_{bleached}/T_{colored})=A_{colored}−A_{bleached} (5)

coloration efficiency=ΔOD/charge density (6)

### Example 3

XPS Element Analysis of Surface

The thin film must be cut by diamond blades before XI′S analysis. Before experiment, the sample surface was cleaned with argon plasma for better energy spectrum identification. The source of X ray was MgKa, it was used to analyze the element pattern on the sample surface and used for semi-quantification.

### Example 4

EDS Analysis of Elements

The thin film must be cut by diamond blades, and coated by sputtering with platinum before EDS analysis. During analysis, the X ray bombarded the inner electrons of atoms in the sample, causing the outer electrons to fall into lower energy level and emit characteristic X ray. With different characteristic X rays emitted by different atoms, a qualitative analysis and semi-quantification analysis of the sample were achieved.

### Example 5

Analysis of Surface Structure

The analysis of surface structure of the thin film was performed with a scanning electron microscope to observe the microstructure of surface of the thin film. This observation revealed whether different additive agents (for example, polymers or surfactants) would cause differences in microstructures (for example, homogeneity of thin film, or the porosity and size of nano particle).

### Example 6

Analysis of Energy-Saying Performance of the Device

Generally, the coloration efficiency (η) served as the criterion for energy-saving performance of an electrochromic device; η was calculated with the following equation:

η=ΔOD/Q=(A_{colored}−A_{bleached})/Q=log(T_{bleached} /T_{colored})/Q (7)

, wherein the ΔOD refers to change in optical density; A_{colored} and A_{bleached} referred to light absorbance of colored state and bleached state (A.U.), respectively; T_{colored} and T_{bleached} referred to light transmittance of colored state and bleached state (%), respectively; Q referred to electrical quantity required by redox reaction per square centimeter (C/cm²). However, for energy-saving window, its ability of modulation in full spectrum could not be shown, if ΔOD was monitored only in single wavelength. Hence the present invention provides another method, which was to calculate integral of the transmittance spectra from colored state to bleached state; the result rendered an evaluation of the optical modulation capacity of an electrochromic device in full spectrum possible. ‘The energy-saving performance of device in use was calculated with the following equation:

energy-saving performance=∫_{λA}^{λB}(T_{B}(λ)T_{C}(λ))·I(λ)dλ (8)

, wherein T_{B} and T_{C} referred to transmittances (%) of the electrochromic device in beached state and colored state, respectively; I(λ) referred to the energy density (W/m²·nm) of sunlight in specific wave length.

Experiment Results

1. Preparation of the Coating Solutions of Prussian Blue and its Analogues

(1) Sizes of Nano Particles in the Ink

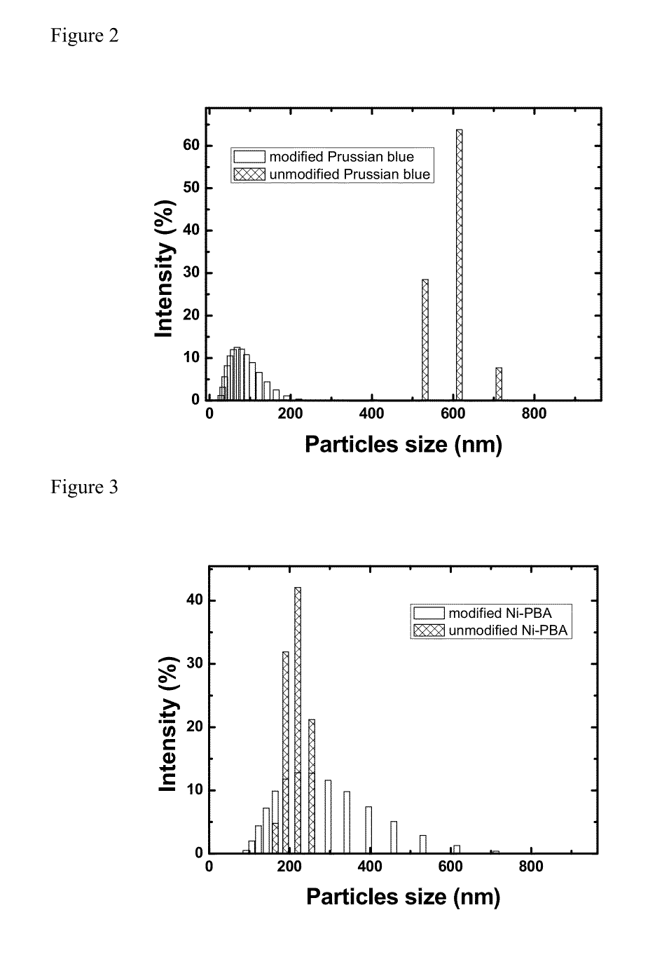

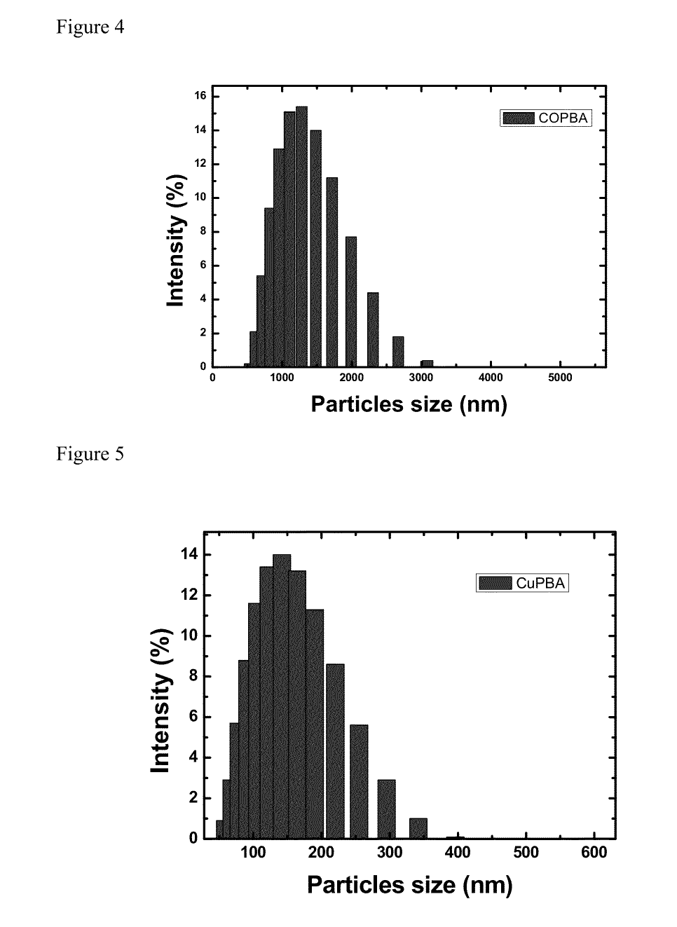

The sizes of Prussian nano particles were analyzed by dynamic light scattering particle size analyzer. As shown in FIG. 2, the sizes of Prussian nano particles decreased significantly after modification with 30% molar concentration of potassium ferrocyanide, the Z-average of particles decreased from 1491 nm to 65.18 nm. And as shown FIG. 3, although the sizes of insoluble nickel hexacyanoferrate nano particles did not decrease, but the size distribution scattered significantly. This method successfully homogenized Prussian particles into fine nano particles in water. In addition, the measurements of soluble cobalt hexacyanoferrate and copper hexacyanoferrate showed that the Z-average of cobalt hexacyanoferrate particles was 1130 nm (FIG. 4), and the Z-average of copper hexacyanoferrate particles was 132 nm (FIG. 5).

(2) Re-Electroneutralization of the Thin Film Surface

After the modification described above, the insoluble Prussian particles ere used to prepare sol-gel. However, because during each coating, the sol-gel would wash away the previously coated thin film, another modification method was employed here, that was to use high concentration (1 M) of nickel chloride solution to re-electroneutralize the surface of the Prussian blue and its analogues, and then the thin film was immersed in deio ized water to remove excess nickel ions. Ferric and nickel ions were estimated to re-electroneutralize the negatively charged ligands and thus prevented them from dissolving in water again.

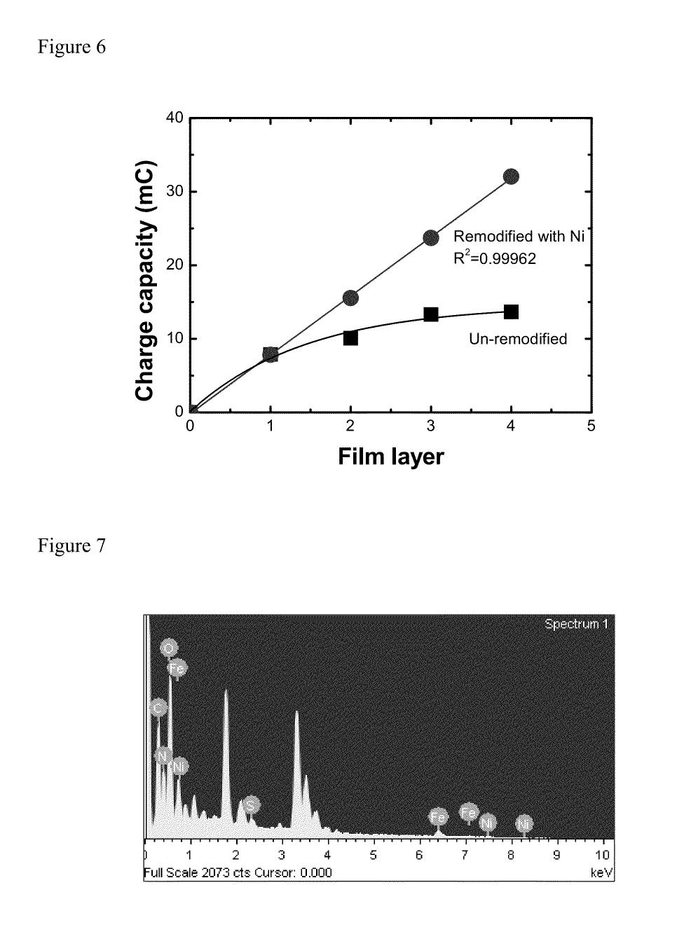

As shown in FIG. 6, the number of times the Prussian blue thin films were coated is in linear relationship with the electric charge quantity on thin film, which demonstrated that during each spin coating, the water-based coating solution wouldn't wash away the coated thin film. On the contrary, the thin film without re-electroneutralization would be washed away during each coating, hence the thin film, would not reach desired thickness.

In EDS analysis of elements, the main constituent elements of Prussian blue were iron, carbon, nitrogen and etc., however, as shown in FIG. 7, there was a significant peak of nickel ions, which indicated that nickel ions have successfully re-electroneutralized the surface of Prussian blue particles.

2. Analysis of the Thin Films of Prussian Blue and its Analogues

In order to investigate the photoelectrical property and surface structure, and to identify the compositions, the Autolab potentiostat/galvanostat, Jasco V-630 spectrometer, XPS, EDS and SEM were employed in the present invention to analyze the physical and chemical properties of Prussian blue, cobalt hexacyanoferrate, nickel hexacyanoferrate and copper hexacyanoferrate, respectively.

(1) Analysis of Physical and Chemical Properties of Prussian Blue

i. Cyclic Voltammetry Analysis and Spectral Characteristic Analysis of Prussian Blue

FIG. 8 showed the CV responses of two different Prussian blue thin films in 1M of sodium perchlorate in propylene carbonate (PC) solution. The difference between the two Prussian blue thin films was with or without PEDOT:PSS polymers. The operational potential window of the electrode was between −0.5V and 1.7V, the scan rate was 100 mV/s. There were two peaks of redox reactions in FIG. 8. The analysis began with −0.5V and increased the voltage gradually, Everrit's salt would exhibit two phases of oxidation, that were to become Prussian blue and Prussian yellow gradually. The first oxidation peak appeared at 0.5V, the thin film turns from colorless into blue, as illustrated by equation 9. After continuing to increase the voltage, Prussian blue would in turn be oxidized to Berlin green, which was light green, as illustrated by equation 10. The second oxidation peak appeared at 1.5V, at this time, most of Prussian blue would be oxidized to Prussian yellow, and hence the thin film became yellow. From equation 10, Berlin green was the mixture of Prussian blue and Prussian yellow. The potentials of the peaks in redox reactions of PW/PB and PB/PY were 0.08/0.49V and 1.5/1.2V, respectively. In addition, after 100 cycles of CV scanning, the Prussian blue thin films remained 95% electrochemical activity, whether it was doped with PEDOT:PSS or not.

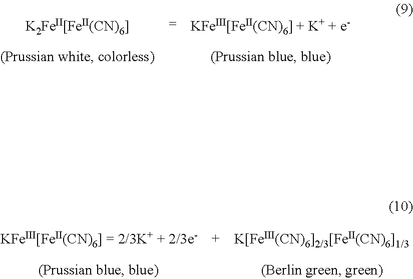

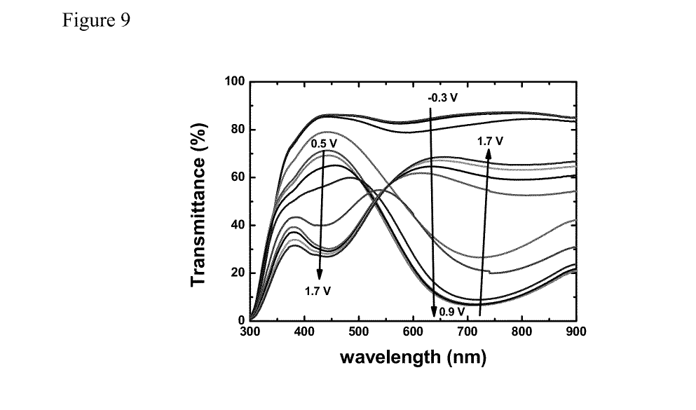

The transmittance spectrum of Prussian blue thin film under different potentials was analyzed by potentiostatic process in combination with spectroheter through full visible spectrum. The potential started from −0.3V to 2.1V, the measurement was performed every 0.2V, The thin film would react under the potential for 30 seconds and then the measurement was performed after the current reaches steady state. As shown in FIG. 9, Prussian white thin film was colorless at −0.3 V, the average of transmittance in visible spectra was above 80%. Due to oxidation, the Prussian white gradually became Prussian blue at 0.3V which was very close to the reactive potential set forth above. When the voltage was at 0.5 V the red light wavelength at 690 nm was blocked, its transmittance was suppressed below 10%, causing the thin film to be blue. As the voltage increases, the transmittance at wavelength from 300 nm to 500 nm gradually decreased, and it decreased rather significantly at 1.3 V, meanwhile red light wavelength was still blocked. The thin film was now light green, from the effect of blue and yellow superposition. When the voltage was at 1.5 V the transmittance at wavelength from 600 nm to 900 nm gradually recovered to more than 60%, the transmittance at wavelength from 300 nm to 500 nm was further suppressed below 30%. If the voltage exceeds 1.5 V, the thin film would appear more vivid yellow; however, the excessive driving force would damage the thin film irreversibly; the electrolyte PC would also start to react and degrade. Hence concluded from the tests described above, an optimal operational potential window for the lifespan and stability of the device would be from −0.5 V to 1.5 V

ii. Analysis of Elements on Prussian Thin Film by XPS

The component elements on the surface of Prussian blue thin film are analyzed by X-ray photoelectron spectroscopy (XPS). The principle of XPS was to emit a laser beam into the sample, due to photoelectric effect, the electrons of surface elements would be excited an become photoelectrons. Because every element possesses its own specific energy spectrum, by measuring the different binding energies carried by these photoelectrons, the elements and corresponding formulas were revealed. On the different thin films of the present invention, besides Prussian blue, there were other metallic complexes analogues; all of them would be confirmed by XPS.

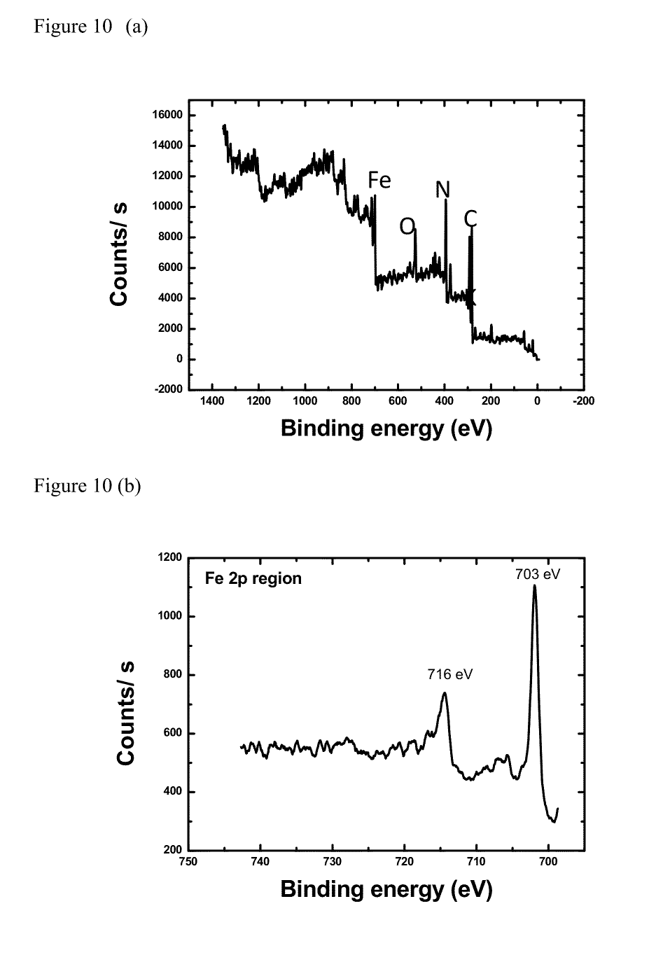

FIGS. 10a and 10b were the results of XPS full spectrum analysis of Prussian blue and microanalysis of iron element, respectively. In FIG. 10a, there were 5 peak-features for Prussian blue. After the comparison to database, the corresponding peaks were carbon, potassium, nitrogen, oxygen, and iron., respectively; which matched the main component elements of Prussian blue. Next, in FIG. 10b, the corresponding binding energy spectrum of iron elements were magnified, the peaks were at 703 eV and 715 eV, which could be the reference for spectrum of iron element in other analogues. If the spectrum of iron element in other analogues showed the same pattern, then it was certain that the prepared thin film is composed of Prussian blue analogues.

iii. Observation of Microstructure of Prussian Blue by SEM Electron Microscope

After XPS analysis, the microstructure on the surface of the Prussian blue thin film was observed by SEM. Also, the SEM was used to observe if the surface structure of thin film was altered by driving voltage or migration of ions after the scanning.

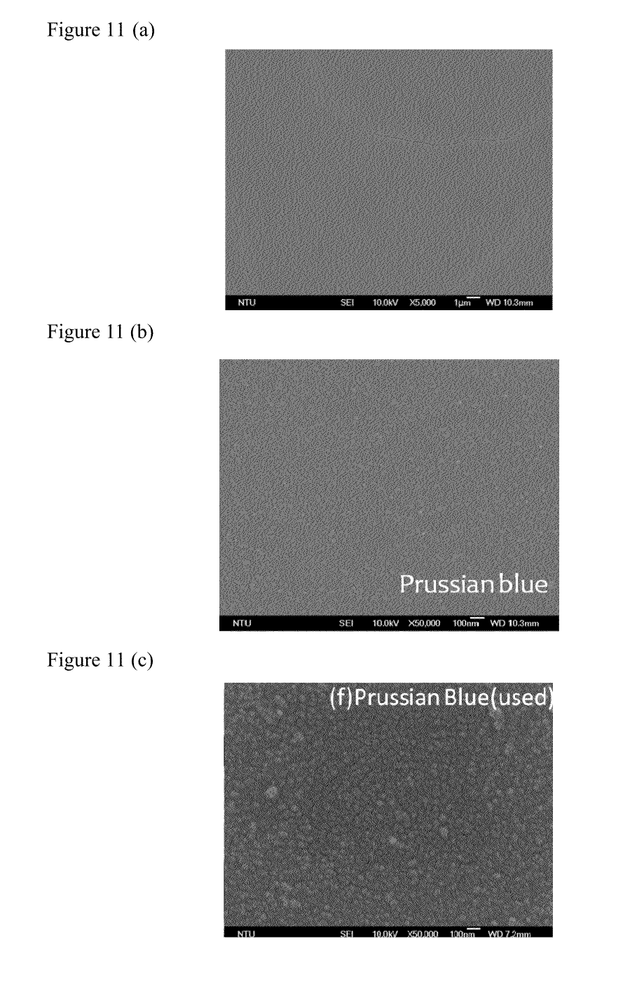

First, the status of the film surface was observed with 5,000 times magnifying power; overall, the surface of Prussian blue thin film was smooth and homogeneous, but there were some rifts (FIG. 11 a) on the surface. The formation of the rifts was probably due to continuous contraction of the PEDOT:PSS doped film during the repetitive soft bake and cooling, or because part of the polymers were drawn away in the highly vacuum environment in SEM. Further, it was seen with 50 k times magnifying power that the film was stacked with the nano particles of Prussian blue and its analogues, the size of the nano particles was ranging from 10 to 20 nm, and there was no distinct pores and rifts (FIG. 11b).

FIG. 11 c showed the surface structure of the Prussian thin film after 100 cycles of CV scanning. Evidently, the gaps between nano particles on the thin film became larger, and so did the size of the nano particles. The migration of the cations driven by the applied voltage was probably the cause of the enlarged gaps, which facilitated the migration.

(2) Analysis of Physical and Chemical Properties of Cobalt Hexacyanoferrate (Co-PBA)

i. Cyclic voltammetry Analysis and Spectral Characteristic Analysis of Cobalt hexacyanoferrate

FIG. 12 showed the CV responses of cobalt hexacyanoferrate in 1 M of sodium perchlorate in propylene carbonate (PC) solution. The operational potential window of the electrode was between −0.5 V and 1.7 V, the scanning speed was 100 mV/s. The reaction was as the following equation 11:

CoHCF_{(oxidized)}+Na⁺+e [symbol] CoHCF_{(reduced)} (11)

There was a redox peak in FIG. 12, the scanning started at −0.5 V, the oxidation peak appeared at 1.0 V, which was the oxidation potential Epa. The color of the thin film turned from magenta to tawny, followed by the reduction of current and completion of reaction. As the potential gradually became negative, the reduction peak appeared at 0.25 V, which was the reduction potential Epc. The color of the thin film turned from tawny back to magenta.

From the above data, the formal potential was calculated as E⁰=(E_{pc}+Eₚₐ)/2, which was 0.63 V (the reference electrode is silver). In addition, after 100 cycles of cyclic voltammetry scanning, whether the thin film was doped with PEDOT:PSS or not, it retained 95% electrochemical activity.

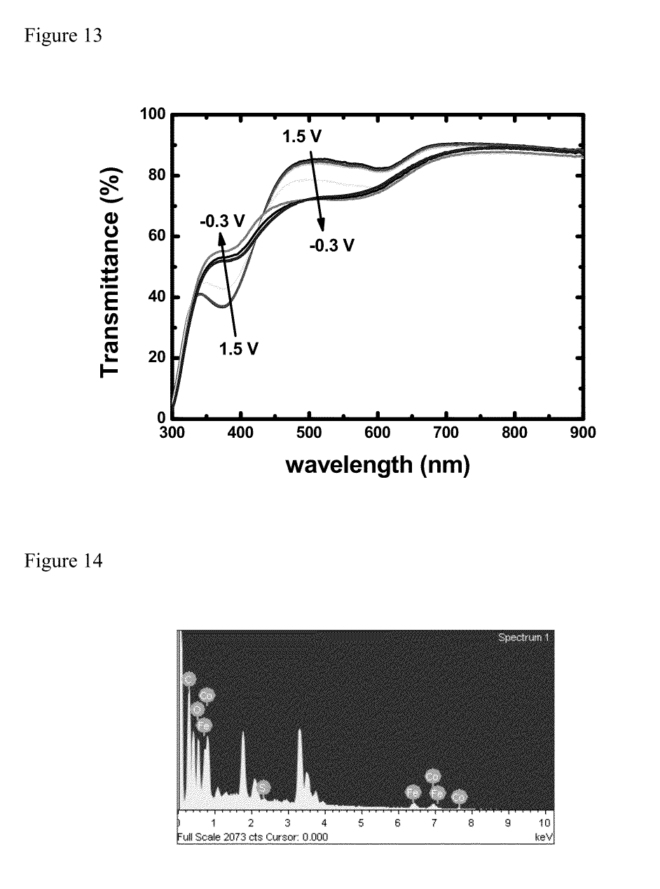

The transmittance spectra of cobalt hexacyanoferrate thin film under different potentials were analyzed by potentiostatic method in combination with spectrometer through full visible light wavelength. The potential starts from −0.3 V to 1.5 V, the measurement was performed every 0.2 V The thin film would react under the potential for 30 seconds and then the measurement was performed after the current reached steady state. As shown in FIG. 13, the blue light wavelength (300 nm-450 nm) of cobalt hexacyanoferrate thin film was suppressed at reduction state, the thin film was thus red; as the potential increases, the color of the thin film started to change at 0.5 V to 0.7 V, which conformed to the formal potential 0.63 V; after the oxidation of the thin film, the transmittance in wavelength of 400 nm to 600 nm decreased, but the transmittance in wavelength of 300 nm to 400 nm increased, thus the color of the thin film turned from magenta to tawny.

ii. Analysis of Elements on Cobalt hexacyanoferrate Thin Film by EDS

The component elements of cobalt hexacyanoferrate thin film were analyzed by energy dispersive spectroscopy (EDS). The EDS result of cobalt hexacyanoferrate thin film in FIG. 14 showed that besides iron, carbon and nitrogen, there was also a peak value for cobalt; the cobalt element was estimated to be 14% of totality. Refer to Prabhu et al., 2011, the formula of cobalt hexacyanoferrate was K₂Co[Fe(CN)₆], and from the EDS results shown in table 1, the ratio of carbon: iron: cobalt is 5.7:0.96:1.4, which was very close to the ratio 6:1:1 as demonstrated in the reference. Thus it was certain that the prepared thin film was composed of cobalt-based Prussian blue analogues.

TABLE 1
The content of elements on cobalt hexacyanoferrate
thin film analyzed by EDS

| elements | weight % | atomic % |
|---|---|---|
| C | 28.67 | 56.90 |
| O | 12.46 | 18.57 |
| S | 0.61 | 0.45 |
| Fe | 22.56 | 9.63 |
| Co | 35.70 | 14.44 |
| Totals | 100.00 | |

iii. Observation of Microstructure of Cobalt hexacyanoferrate Thin Film by SEM

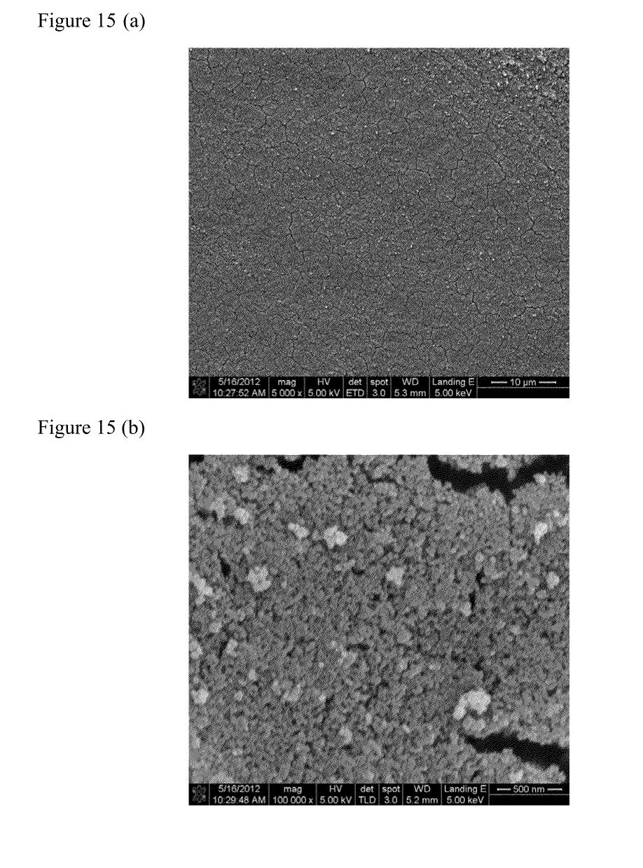

FIGS. 15a and 15b showed the microstructure of cobalt hexacyanoferrate thin film under 5 k and 100 k magnifications. With 5 k magnification, the surface of the thin film was seen to be very homogeneous and compact, yet the thin film was also covered by fine rifts. With 100 k magnification, it was observed that the cobalt hexacyanoferrate thin film was stacked with minute spherical particles, the fine and compact rifts were between the particles; the size distribution of the particles was between 25 nm to 50 nm.

(3) Analysis of Physical and Chemical Properties of Nickel-Based Prussian Blue Analogues (Ni-PBA)

i. Cyclic Voltammetry Analysis and Spectral Characteristic Analysis of Nickel hexacyanoferrate

FIG. 16 showed the CV responses of nickel hexacyanoferrate in 1M of sodium perchlorate in propylene carbonate (PC) solution. The operational potential window of the electrode was between −0.5 V and −1.3 V the scanning speed was 100 mV/s. The reaction was as the following equation 12:

NiHCF_{(oxidized)}+Na⁺+e [symbol] NiHCF_{(reduced)} (12)

There was a redox peak in FIG. 16, the scanning started at −0.5 V, the oxidation peak appeared at 1.1 V, which was the oxidation potential Epa. The color of the thin film turned from colorless to yellow, followed by the reduction of current and completion of reaction. As the potential gradually became negative, the reduction peak appeared at 0.1 V, which was the reduction potential Epc. The color of the thin film turned from yellow back to magenta. From the above data, the formal potential was calculated as E⁰=(E_{pc}+Eₚₐ)/2, which was 0.6V (the reference electrode is silver). In addition, after 100 cycles of cyclic voltammetry scanning, whether the thin film was doped with PEDOT:PSS or not, it retained 96% electrochemical activity.

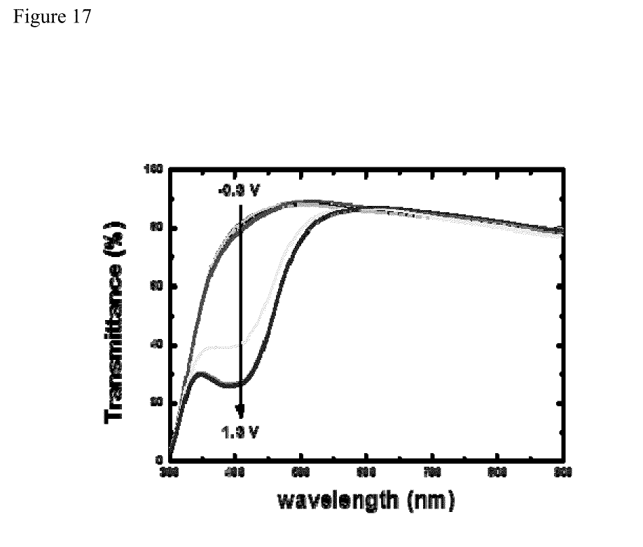

The transmittance spectra of nickel hexacyanoferrate thin film under different potentials were analyzed by potentiostatic method in combination with spectrometer through full visible light wavelength (200 nm-900 nm). The potential started from −0.3 V to 1.3 V, the measurement was performed every 0.2 V. The thin film would react under the potential for 30 seconds and then the measurement was performed after the current reached steady state. As shown in FIG. 17, the overall transmittance of reduced nickel hexacyanoferrate for visible light was above 80%, the thin film was colorless; as the potential increased, the color of the thin film started to change at 0.5 V to 0.7 V, which conformed to the formal potential 0.6 V; after the oxidation of the thin film, the transmittance in wavelength of 300 nm to 500 nm (purple light) decreased, the color of the thin film turned to yellow, which was the contrasting color. The transmittance of the thin film reached the maximum modulation amplitude (56%, 78%-22%) at 400 nm.

ii. Analysis of Elements on Nickel hexacyanoferrate Thin Film by XPS

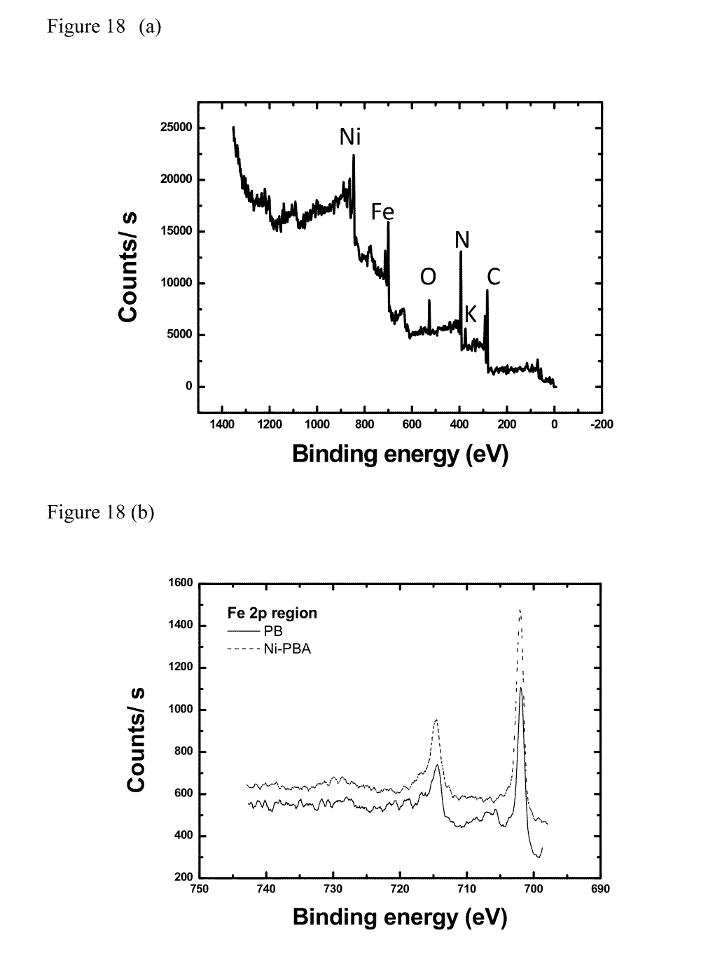

FIG. 18a was the result of XPS full spectrum analysis of nickel hexacyanoferrate thin film, there were six peak-features. After the comparison to database, the corresponding peaks were carbon, potassium, nitrogen, oxygen, iron and nickel respectively; which matched the main component elements of nickel-based Prussian blue analogues. Next, in the comparison between micro-area scanning results of Prussian blue and nickel hexacyanoferrate (FIG. 18b), the two binding energy spectra of nickel hexacyanoferrate were at 703 eV and 716 eV, respectively, which conformed to the binding energy spectra of iron element in Prussian blue. Thus it was certain that the prepared thin film was composed of nickel-based Prussian blue analogues.

iii. Observation of Microstructure of Nickel hexacyanoferrate by SEM

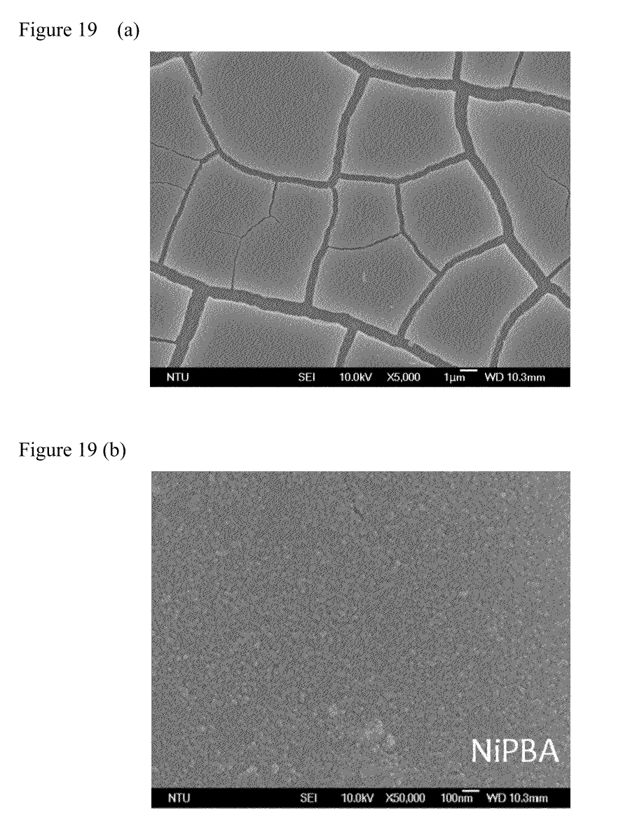

First, the status of the thin film surface was observed with 5,000 times magnifying power; the surface of nickel hexacyanoferrate thin film was smooth and homogeneous, but there were some large rifts (FIG. 19a). As described above, the formation of the rifts was probably due to continuous contraction of the PEDOT:PSS doped film during the repetitive soft bake and cooling, or because part of the polymers were drawn away in the highly vacuum environment in SEM. Further, it was seen with 50 k times magnifying power that the film was stacked with the nano particles of nickel hexacyanoferrate, the size of the nano particles was ranging from 10 to 20 nm, and there was no distinct pores and rifts (FIG. 19h).

(4) Analysis of Physical and Chemical Properties of Copper-Based Prussian Blue Analogues (Cu-PBA)

i. Analysis of Electrochemical and Spectral Properties of Copper hexacyanoferrate

FIG. 20 showed the CV responses of two different copper hexacyanoferrate thin films. The operational potential window of the electrode was between −0.5V and 1.8 V, the reaction was as the following equation:

CuHCF_{(oxidized)}+Na⁺e [symbol] CuHCF_{(reduced)} (13)

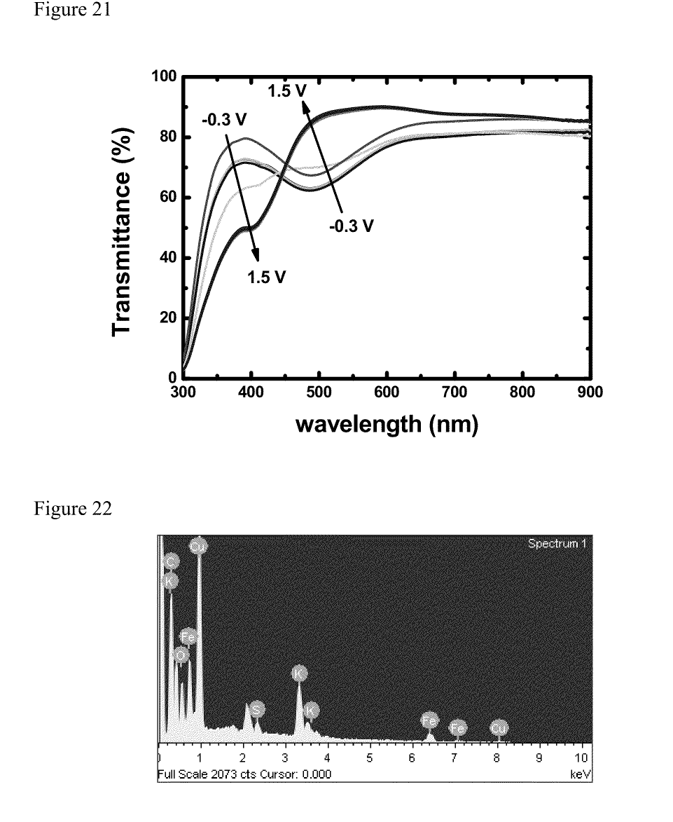

As shown in the figure, there was an oxidation peak of the copper hexacyanoferrate thin film at 1.0 V, which was the oxidation potential Epa, and followed by the reduction of current and completion of reaction. The color of the thin film turns from magenta to tawny. As the potential gradually becomes negative, the reduction peak appeared at 0.2 V, which was the reduction potential Epc. The color of the thin film turns from yellow back to colorless. From the above data, the formal potential of copper hexacyanoferrate was calculated, which was about 0.6 V (the reference electrode was silver). In addition, after 100 cycles of cyclic voltammetry scanning, whether the thin film was doped with PEDOT:PSS or not, it retained 96% electrochemical activity. In FIG. 21, the transmittance spectra result showed that the wavelength at 500 nm was suppressed as the copper hexacyanoferrate thin film was in oxidation state, and the thin film was faint red. After the thin film was oxidized, the transmittance decreases at the wavelength of 300 nm to 450 nm, but it increased significantly at the wavelength of 450 nm to 900 nm, and the color turned form magenta to light yellow. Although the copper hexacyanoferrate was a bicolored chromic material, just like the cobalt hexacyanoferrate, the transmittance of copper hexacyanoferrate was suppressed only at the wavelength of 400 nm to 450 nm, hence it was chosen to be combined with other chromic materials to form devices in later embodiments.

ii. Analysis of Elements on Copper hexacyanoferrate Thin Film by EDS

The precipitants from the mixture of copper sulfate and potassium ferricyanide were used in the coating g process, and the precipitants were estimated to be copper hexacyanoferrate. The EDS analysis was used to confirm that the precipitants were copper hexacyanoferrate.

The EDS result of copper hexacyanoferrate thin film in FIG. 22 showed that besides iron, carbon and nitrogen, there was also a peak value for copper; the copper element was estimated to be 14% of totality. Refer to Lisowska-Oleksiak et al. 2011, the formula of copper hexacyanoferrate was K₂Cu[Fe(CN)₆], and from the EDS results shown in table 2, the ratio of carbon: iron: copper was 5.6:1.4:1.4, which was very close to the ratio 6:1:1 as demonstrated in the reference. Thus it was certain that the prepared thin film was composed of copper-based Prussian blue analogues.

TABLE 2
The content of elements on copper hexacyanoferrate
thin film analyzed by EDS

| elements | weight % | atomic % |
|---|---|---|
| C | 24.65 | 55.51 |
| O | 6.81 | 11.52 |
| S | 1.30 | 1.10 |
| K | 6.03 | 4.17 |
| Fe | 28.02 | 13.57 |
| Cu | 33.18 | 14.13 |
| Totals | 100.00 | |

iii. Observation of Microstructure of Copper hexacyanoferrate by SEM

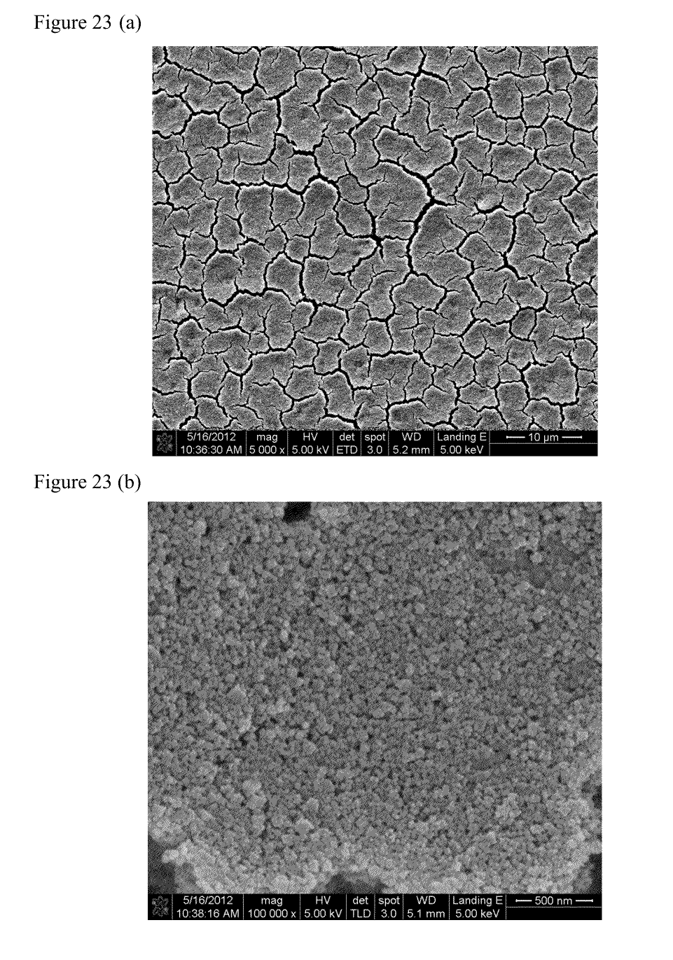

The microstructure on the surface of the copper hexacyanoferrate thin film was observed by SEM. FIG. 23 showed the microstructure of copper hexacyanoferrate thin film under 5 k and 100 k magnifications. With 5 k magnification, the surface of the thin film was seen to be covered by rifts. With 100 k magnification, it was observed that the copper hexacyanoferrate thin film was stacked with minute square particles; the size distribution of the particles was between 40 nm to 70 nm, both the shape and size were significantly different from those of Prussian blue, cobalt hexacyanoferrate and nickel hexacyanoferrate.

(5) Analysis of Physical and Chemical Properties of Zinc-Based Prussian Blue Analogues (Zn-PBA) 1. Observation of Microstructure of Zinc hexacyanoferrate by SEM

The microstructure on the surface of the zinc hexacyanoferrate thin film was observed by SEM. FIG. 30 showed the microstructures of zinc hexacyanoferrate thin films with different concentration.

ii. Analysis of Electrochemical Properties of Zinc hexacyanoferrate

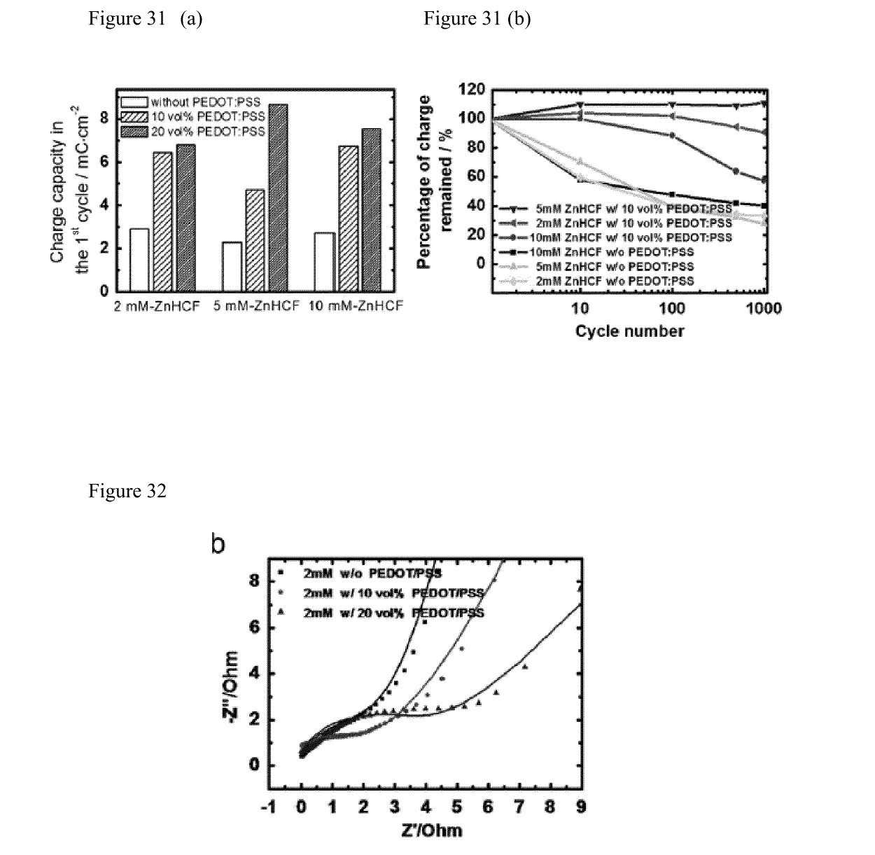

FIG. 31 showed the electrical quantities left on the anodes of the thin films after the first cycle of cyclic voltammetry scanning and after various cycles of cyclic voltammetry scanning, wherein the thin films were with different concentrations of zinc hexacyanoferrate in combination with different concentrations of PEDOT:PSS. Then the EIS spectra of the thin films with different concentrations of zinc hexacyanoferrate in combination with different concentrations of PEDOT:PSS were analyzed. Table 3 showed the diffusion coefficients of lithium ion measured according to Randles-Sevcik equation in the thin films with different concentrations of zinc hexacyanoferrate in combination with different concentrations of PEDOT:PSS.

TABLE 3

| | | diffusion | diffusion |
|---|---|---|---|
| | concentration of | coefficient of | coefficient of |
| concentration of | PEDOT:PSS | anodic reaction | cathodic reaction |
| Zn-PBA (mM) | (v/v %) | (cm²/s) | (cm²/s) |
| 10 | 0 | 1.85 × 10⁻¹⁰ | 8.98 × 10⁻¹¹ |
| | 10 | 1.54 × 10⁻⁹ | 1.25 × 10⁻⁹ |
| | 20 | 1.72 × 10⁻⁹ | 1.83 × 10⁻⁹ |
| 5 | 0 | 8.78 × 10⁻¹¹ | 3.68 × 10⁻¹¹ |
| | 10 | 1.35 × 10⁻⁹ | 9.30 × 10⁻¹⁰ |
| | 20 | 5.06 × 10⁻⁹ | 3.23 × 10⁻⁹ |
| 2 | 0 | 2.60 × 10⁻¹⁰ | 1.79 × 10⁻¹⁰ |
| | 10 | 3.30 × 10⁻⁹ | 1.96 × 10⁻⁹ |
| | 20 | 4.75 × 10⁻⁹ | 3.91 × 10⁻⁹ |

Table 4 showed the EIS fitted parameters of the thin films with different concentrations of zinc hexacyanoferrate in combination with different concentrations of PEDOT:PSS measured by equivalent electric circuit (FIG. 36).

TABLE 4

| | | | | | | | | | |
|---|---|---|---|---|---|---|---|---|---|
| concentration of | 10 | 10 | 10 | 5 | 5 | 5 | 2 | 2 | 2 |
| Zn-PBA (mM) | | | | | | | | | |
| concentration of | 0 | 10 | 20 | 0 | 10 | 20 | 0 | 10 | 20 |
| PEDOT:PSS (v/v %) | | | | | | | | | |
| resistance of | 13.49 | 7.75 | 8.34 | 11.64 | 14.16 | 10.8 | 7.73 | 13.86 | 13.13 |
| electrolyte/substrate | | | | | | | | | |
| (Ohm) | | | | | | | | | |
| electric double-layer | 1.378 | 13.7 | 10.57 | 1.47 | 2.482 | 3.52 | 3.32 | 1.81 | 3.48 |
| capacitance (μF) | | | | | | | | | |
| Charge transfer | 1.815 | 4.93 | 4.39 | 1.877 | 3.52 | 4.11 | 2.803 | 2.148 | 3.65 |
| resistance (Ohm) | | | | | | | | | |
| Inter-particulate | 26.11 | 155.3 | 394 | 26.02 | 146.7 | 603 | 29.78 | 164 | 1126 |
| capacitance (μF) | | | | | | | | | |
| Warburg diffusion | 4.66 × | 5.23 × | 7.20 × | 4.49 × | 6.04 × | 1.08 × | 3.15 × | 3.69 × | 4.59 × |
| element | 10⁻³ | 10⁻³ | 10⁻³ | 10⁻³ | 10⁻³ | 10⁻³ | 10⁻³ | 10⁻³ | 10⁻³ |

3. The Compound Film of Prussian Blue and its Analogues

The compound film of the present invention was composed of Prussian blue and its nickel-based analogue, and it successfully extended the range of transmittance modulation in the wavelength of 300 nm to 500 nm. Finally, the compound film of Prussian blue and nickel hexacyanoferrate was combined with copper hexacyanoferrate thin film to form a multi-color complementary electrochromic device.

(1) The Compound Film of Prussian Blue and its Nickel-Based Analogue

FIG. 24 showed the CV responses of the compound film composed of Prussian blue and its nickel-based analogue layer-by-layer. The electrolyte was still 1M of sodium perchlorate in propylene carbonate (PC) solution. The operational potential window of the electrode was between −0.5 V and 1.7 V, the scanning rate was 100 mV/s. There were two peaks of redox reactions, the left one was generated by the redox reaction of Prussian blue and Prussian white, the oxidative and reductive peak values were at 0.504 V and −0.123 V respectively; the right one was generated by the redox reaction of Prussian blue, Prussian yellow and nickel hexacyanoferrate, the oxidative and reductive peak values were at 1.4 V and 1.0 V respectively. These two reactions were probably combined to form one redox peak due to the proximity of their original peaks under the high scanning speed.

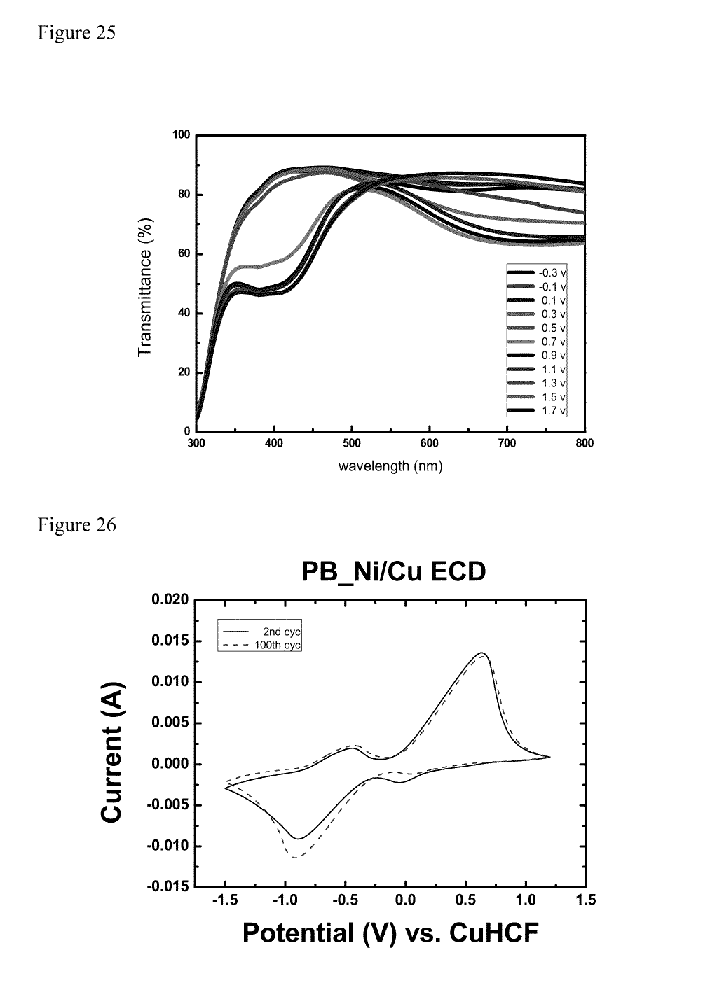

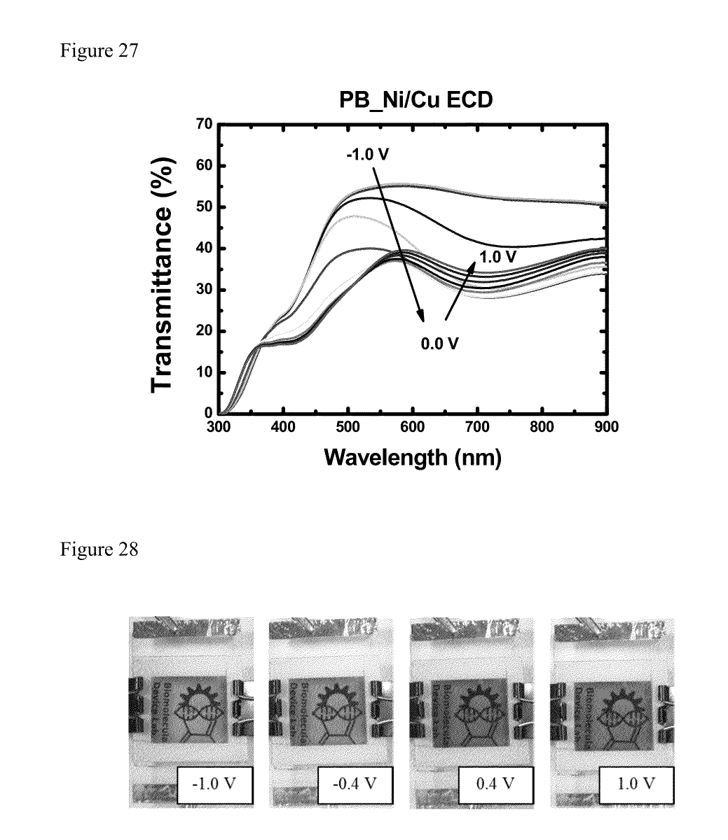

The transmittance spectra of the compound film under different potentials were shown in FIG. 25, the analysis scanning begins at −0.3 V, and it was colorless. As the potential was at 0.3 V, the transmittance at 550 nm to 800 nm was suppressed gradually, and the color was blue. The variation of transmittance reached maximum at the wavelength of 690 nm at 0.7 V, and the transmittance started to decrease at the wavelength of 300 nm to 500 nm, this acted as the sign that the oxidation of nickel-based analogue begins. At the range of potential between 0.7 V and 1.1 V, the thin file appeared to be green, which was the blend of yellow nickel-based analogue and Prussian blue. When the potential increased over 1.3 V most Prussian blue would be oxidized to Prussian yellow, in combination with nickel-based analogue the thin film would display vivid yellow.

(2) Complementary Devices of Prussian Blue and its Analogues

Complementary electrochromic devices of Prussian blue, nickel hexacyanoferrate-copper hexacyanoferrate (PNCECD)

The spectral analysis of the compound film revealed that the nickel. hexacyanoferrate modulated the spectra at wavelength of 300 nm to 500 nm, but not the wavelength at 500 nm to 600 nm. The cobalt and copper-based analogues just possessed the modulation capacity at the wavelength of 400 nm to 600 nm. However, cobalt hexacyanoferrate was a bi-colored chromic material that appeared to be maroon at oxidation state, and red at reduction state; hence, for the application of smart window, although it could modulate the transmittance at the wavelength of 500 nm to 600 nm, but it would also interfere with the transparency. On the other hand, besides the modulation capacity at the wavelength over 450 nm, copper hexacyanoferrate remained certain transparency at oxidation state, thus it was chosen to be combined with the compound

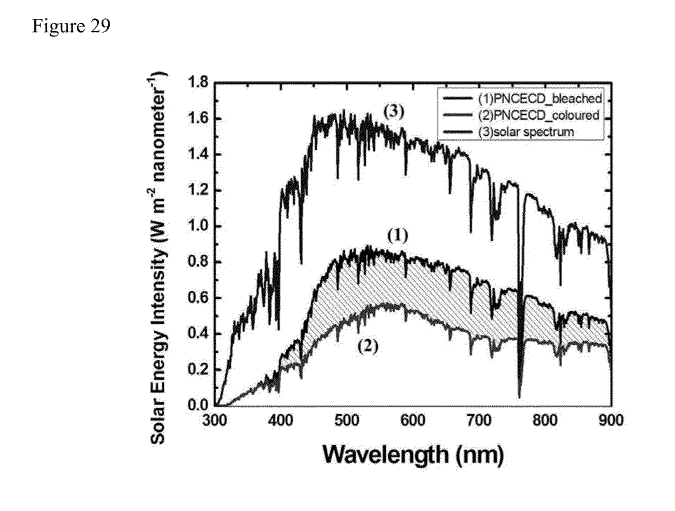

FIG. 26 showed the CV responses of the PNCECD, the Prussian-nickel hexacyanoferrate compound film was the working electrode, and the copper hexacyanoferrate was the counter electrode. The electrolyte was still 1 M of sodium perchlorate in propylene carbonate (PC) solution. The operational potential window of the electrode is between −1.5V and 1.2 V, the scanning rate was 100 mV/s. There were two peaks of redox reactions, the potential started from −1.0 V to 1.0 V, the measurement was performed every 0.2 V. The complementary device would react under the potential for 30 seconds and then the measurement was performed after the current reaches steady state. The device appeared the light yellow of cobalt hexacyanoferrate at −1.0 V When the potential reached −0.4 V, the Prussian blue was oxidized gradually, and the device appeared to be blue. As the working electrode being oxidized gradually, it would appear to be green, which was in combination with the counter electrode of red reduced copper hexacyanoferrate, and these together rendered the complementary electrochromic device the optimal modulation capacity over full spectra at 0.2 V While the potential was at 1.0 V, the Prussian blue was further oxidized to Prussian yellow, therefore the device appeared to be red (FIG. 28). The energy-saving performance of the device was 125.01W/m² (FIG. 29).

4. Comparison between PEDOT:PSS and Conductive Carbon Gel

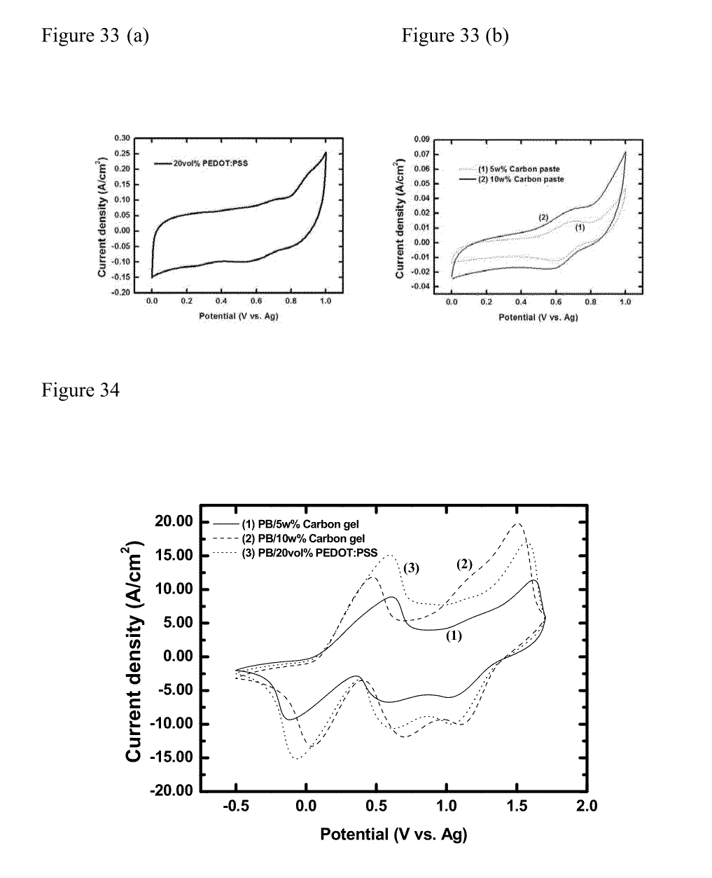

From FIG. 33, which showed the comparison between the CV responses of 20% PEDOT:PSS (v/v), 5% and 10% carbon gel (w/w), the carbon gel (non-conductive polymer) also possessed the electrochemical capacitor property. PEDOT:PSS and conductive carbon gel were also added into the Prussian blue coating solution, respectively; and then the CV responses of resulted thin films were monitored, as shown in FIG. 34. The Prussian blue thin film with carbon gel also exhibited significant color variation.

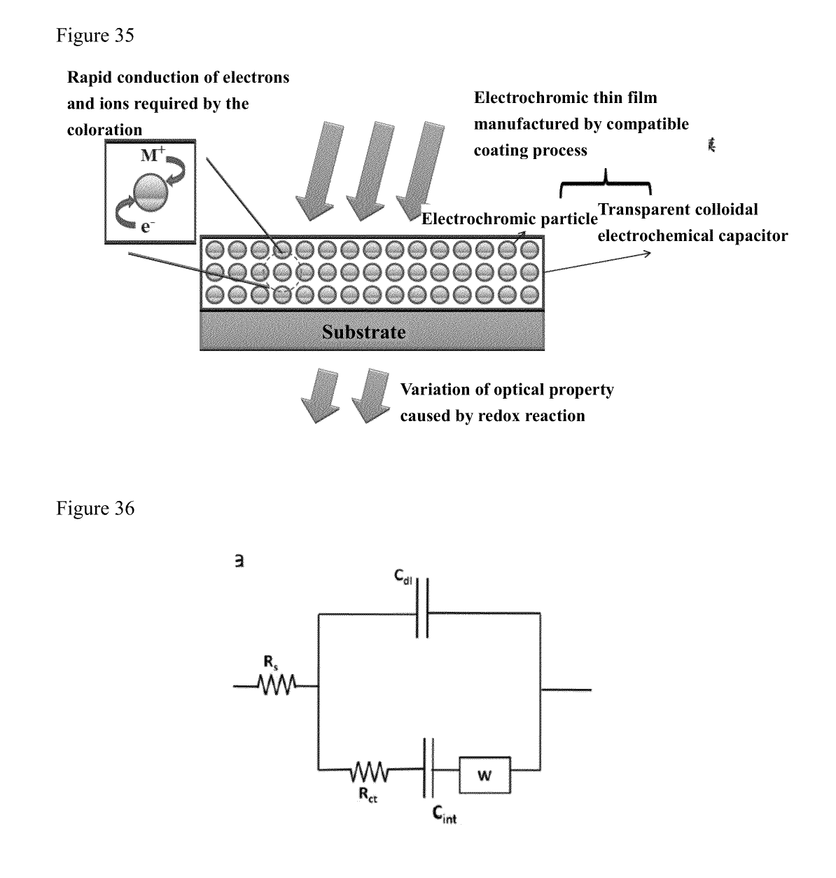

FIG. 35 showed the mechanism of the present invention, and its equivalent circuit was calculated, as shown in FIG. 36.

5. Comparison between Conductive polymers and Non-Conductive Polymers

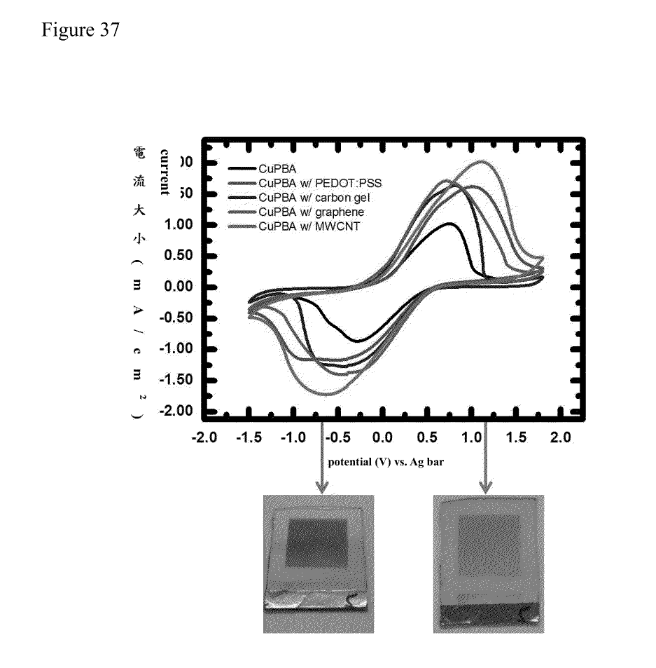

FIG. 37 showed the CV responses of the thin films of copper hexacyanoferrate doped with PEDOT:PSS, carbon gel, graphene or multiwall carbon nanotubes (MWCNT), respectively. Both conductive polymers and non-conductive polymers can enhance the capacitance property in the thin films of Prussian blue or its analogues nano particles, and the thin films showed significant coloration.

1. An optically variable thin film, which comprises single layer or multi-layer of single type or plural types of optically variable particles, wherein the optically variable particles are embedded by transparent colloidal materials with electrochemical capacitance property.

2. The optically variable thin film of claim 1, wherein the optically variable particles are embedded by transparent colloidal materials with electrochemical capacitance property and enhance a transfer of electrons and ions required by the coloration of the optically variable particles.

3. The optically variable thin film of claim 2, wherein the enhancement of transfer of electrons and ions required by the coloration of the optically variable particles leads to an optically variable thin film with higher optical density, higher contrast, more uniform coloration, better reversibility or longer lifespan.

4. The optically variable thin film of claim 1, wherein the optically variable particles embedded by transparent colloidal materials with electrochemical capacitance property generate electrochemical capacitance effect between the optically variable particles in the thin film.

5. The optically variable thin film of claim 1, wherein the transparent colloidal materials with electrochemical capacitance property are selected from the group consisting of inorganic transparent colloidal materials with electrochemical capacitance property, organic transparent colloidal materials with electrochemical capacitance property and mixtures thereof.

6. The optically variable thin film of claim 1, wherein the optically variable particles change their optical properties due to redox reactions, and are dispersed homogeneously in transparent colloidal materials with electrochemical capacitance property due to chemical modifications on the surfaces of particles.

7. The optically variable thin film of claim 1, wherein the optically variable particles are selected from the group consisting of organic micron optically variable particles, inorganic micron optically variable particles, organic nano optically variable particles, inorganic nano optically variable particles and mixtures thereof.

8. The optically variable thin film of claim 1, wherein the optically variable particles are electrochromic particles.

9. The optically variable thin film of claim 8, wherein the electrochromic particles are selected from the group consisting of Prussian blue, cobalt hexacyanoferrate, nickel hexacyanoferrate, copper hexacyanoferrate, indium hexacyanoferrate, zinc hexacyanoferrate and mixtures thereof.

10. The optically variable thin film of claim 1, wherein when the optically variable thin film comprises two or more kinds of optically variable particles, the optical properties of the different kinds of optically variable particles do not interfere with each other.

11. A device with optically variable appearance, wherein the configuration of the device comprises the optically variable thin film of claim 1.
